(19) United States
(12) Patent Application Publication
(10) Pub. No.: US 2021/0269302 A1
(43) Pub. Date: Sep. 2, 2021

(54) TRANSPORT VESSEL FILLING APPARATUS, SYSTEMS, AND METHODS

(71) Applicant: Westmor Industries, LLC, Morris, MN (US)

(72) Inventors: Mike Hennen, Morris, MN (US); John Cooper, Morris, MN (US)

(21) Appl. No.: 17/184,228

(22) Filed: Feb. 24, 2021

Related U.S. Application Data
(60) Provisional application No. 62/983,169, filed on Feb. 28, 2020.

(51) Int. Cl. B67D 7/42; B67D 7/00; B67D 7/58; B67D 7/78; B67D 7/84

(52) U.S. Cl. CPC B67D 7/42; B67D 7/005; B67D 7/84; B67D 7/78; B67D 7/58

(57) ABSTRACT

Transport vessel filling systems, methods and apparatus are described. Some embodiments include liquid fill nozzle assemblies. Some liquid fill nozzle assemblies are in fluid communication with a sprayfill standpipe. Some liquid fill nozzle assemblies include a plurality of liquid fill nozzle assemblies configured to extend to on one or both lateral sides of a vessel.

### BACKGROUND

Transport vessels are used to deliver products such as fuel in liquid and/or gaseous state. Some vessels are configured to be filled with product via one or more fill nozzles.

### BRIEF DESCRIPTION OF THE DRAWINGS

FIG. 1 is a side elevation view of an embodiment of a trailer supporting an embodiment of a transport vessel.

FIG. 2 is a side elevation view of the vessel of FIG. 1.

FIG. 3 is a sectional view along section 3-3 of FIG. 2.

FIG. 4 is a front elevation view of an embodiment of a fill nozzle assembly coupled to the vessel of FIG. 1.

FIG. 5 is a side elevation view of the fill nozzle assembly of FIG. 4.

FIG. 6 is a plan view of the fill nozzle assembly of FIG. 4.

### DESCRIPTION

Transport vessel filling systems, methods and apparatus are described herein. Some embodiments include liquid fill nozzle assemblies. Some liquid fill nozzle assemblies are in fluid communication with a sprayfill standpipe. Some liquid fill nozzle assemblies include a plurality of liquid fill nozzle assemblies configured to extend to on one or both lateral sides of a vessel.

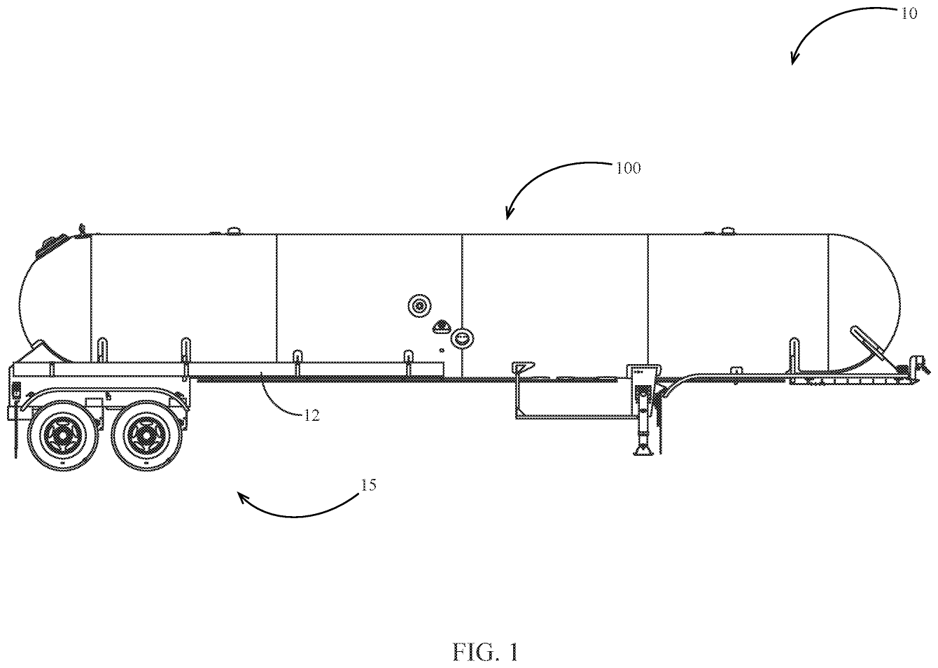

Referring to the drawings, wherein like reference numerals designate identical or corresponding parts throughout the several views, FIG. 1 illustrates an embodiment of a trailer 10 comprising a wheeled chassis 15 at least partially supporting a transport vessel 100. The vessel 100 is optionally mounted to rails 12 for mounting to the chassis 15.

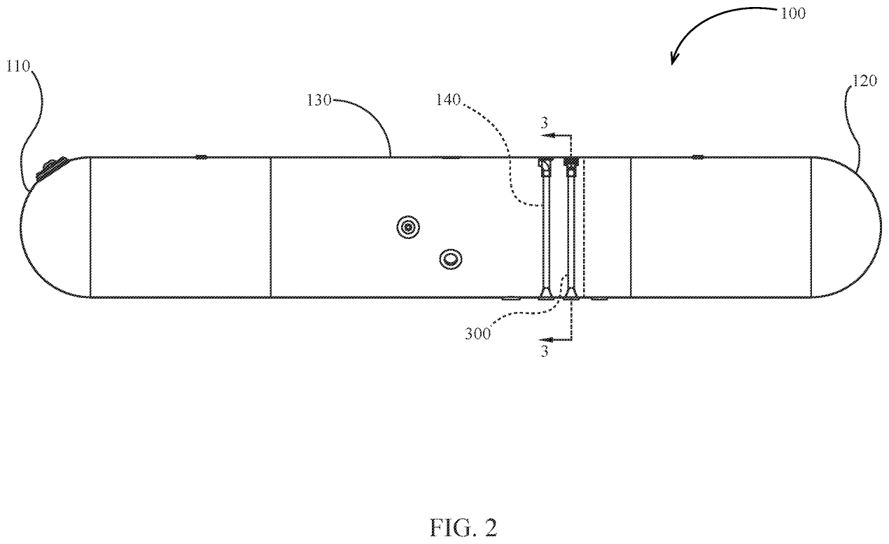

Referring to FIG. 2, the vessel 100 optionally includes a cylindrical shell 130 mounted (e.g., by welding at a first annular seam) to a rear head 110 (e.g., a semi-spherical shell) and mounted (e.g., by welding at a second annular seam) to a forward head 120 (e.g., a semi-spherical shell). The vessel 100 and one or more internal components thereof are optionally made of a metal such as steel.

In some embodiments, a standpipe 140 is supported in the vessel 100 and in communication with an opening in the vessel. In some embodiments one or more outlets in the upper end of the standpipe 140 are disposed at an upper portion of vessel 100, e.g., in a vapor space of the vessel during operation. Some embodiments do not include standpipe 140.

In some embodiments, an additional or alternatively a different standpipe 300 (see FIG. 2) is supported in the vessel 100 and in communication with an opening in the vessel. In some embodiments one or more outlets in the upper end of the standpipe 300 are disposed at an upper portion of vessel 100, e.g., in a vapor space of the vessel during operation.

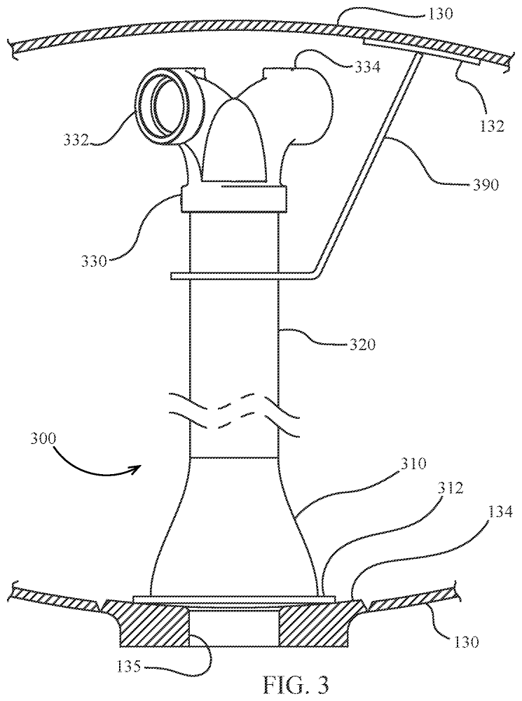

Referring to FIG. 3, the standpipe 300 is illustrated in more detail. The standpipe 300 optionally includes an inlet portion 310 (e.g., reducing coupler), an optionally upwardly extending conduit portion 320 (e.g., a hollow cylindrical-shaped portion), and an outlet 330 (e.g., a tee such as model no. MEP995S-24/16 available from Marshall Excelsior in Marshall, Mich.). The inlet portion 310 is optionally in fluid communication with an opening 135 in the vessel 100. The inlet portion 310 (e.g., an annular lip 312 thereof) is optionally coupled (e.g., welded) to a flange 134 in which opening 135 is optionally formed. The flange 134 is optionally coupled (e.g., welded) to an opening in a lower end of shell 130.

The outlet 330 is optionally in fluid communication with the inlet portion 310 via the conduit portion 320. The outlet 330 includes one or more openings 332, 334. In some embodiments, a height of the standpipe 300 is greater than half a height of the shell 130. In some embodiments, the height of the standpipe 300 can be 60%, 70%, 80%, 90% or other values between 50 and 100% of the height of the shell 130. In some embodiments, a distance of the outlet 330 above a lower surface of the shell 130 is greater than half a height of the shell 130. In some embodiments, the distance of the outlet 330 above the lower surface of the shell 130 can be 60%, 70%, 80%, 90% or other values between 50 and 100% of the height of the shell 130. In some embodiments a central axis of one or more of the openings 332, 334 is generally horizontally oriented and/or at an angle (e.g., 90 degrees, approximately 90 degrees, between 60 and 90 degrees, between 45 and 90 degrees, etc.) with respect to a central axis of the conduit portion 320. The standpipe 300 is optionally supported at an upper end thereof (e.g., below the outlet 330) by a support bracket 390. The support bracket 390 is optionally supported on an interior surface of the vessel such as at an upper end of the vessel (e.g., the support bracket may be mounted to a pad 132 which is in turn mounted to the interior surface of the vessel).

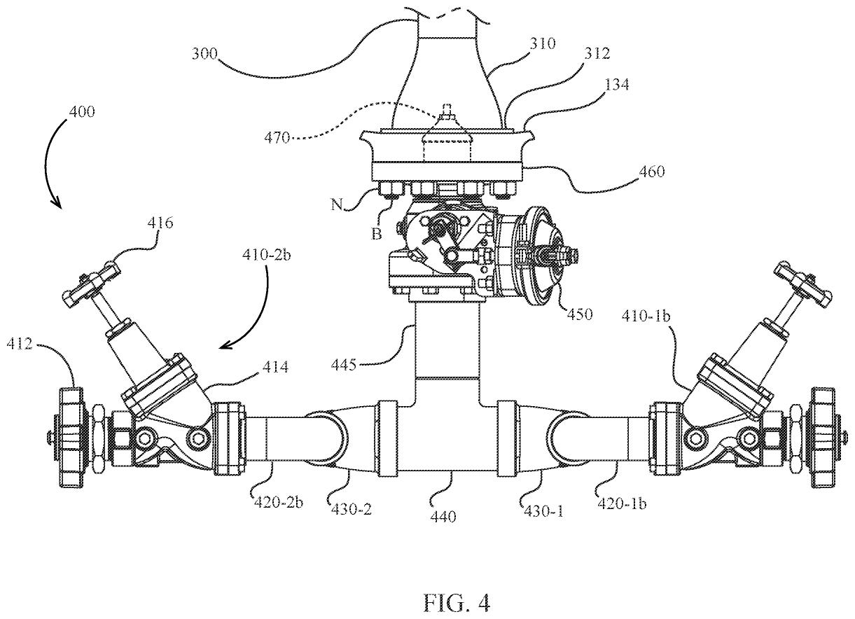

Referring to FIG. 4, a fill nozzle assembly 400 is shown coupled to the flange 134 of vessel 100. In operation, one or more fill nozzles 410 may be used to place one or more supply hoses (e.g., liquid supply hose) in fluid communication with the vessel 100 (e.g., via outlet 330) via. In some implementations, a liquid is supplied into a vapor space (e.g., upper volume of the vessel 100 disposed a lower volume of liquid) via the fill nozzle assembly 400 and/or the standpipe 300.

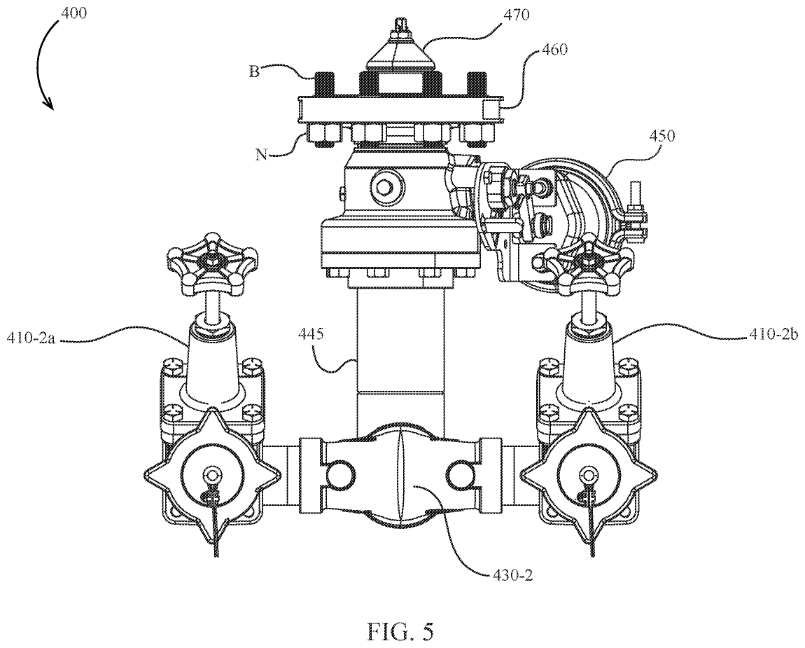

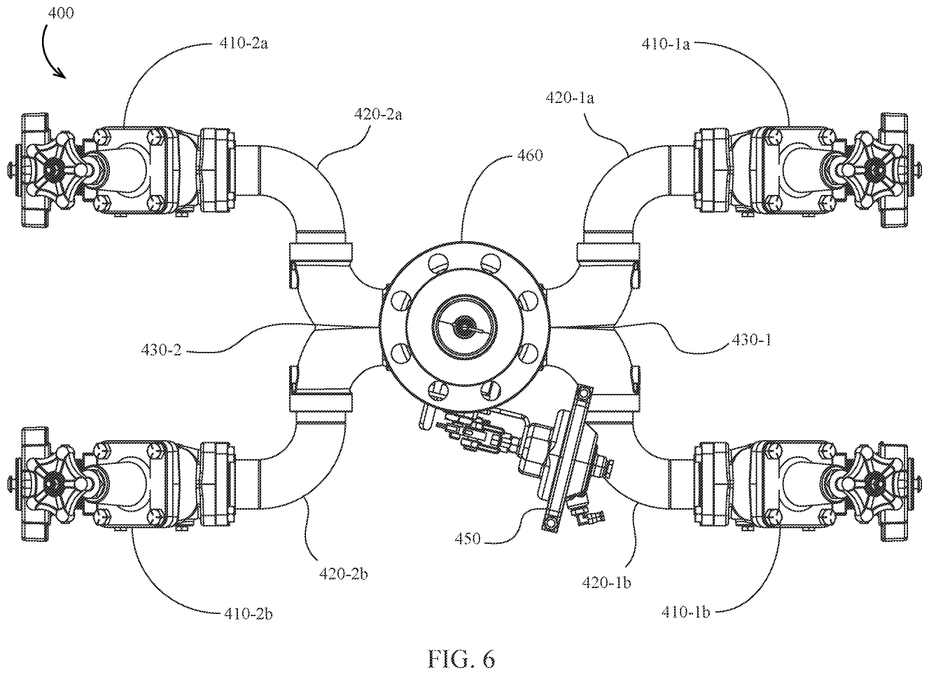

Referring to FIGS. 4-6, the fill nozzle assembly 400 is illustrated in more detail. Each fill nozzle 410 optionally includes a removable cap 412, valve body 414 and a valve controller 416. Each fill nozzle 410 optionally comprises a valve (e.g., within valve body 414) for selectively opening and closing the nozzle 410 to fluid flow. In some embodiments, each fill nozzle 410 is in fluid communication with the vessel 100. In the illustrated embodiment, each fill nozzle 410 is in fluid communication with the vessel 100 via one or more of the following (e.g., in the sequence listed herein): an elbow 420, a tee 430, a central fitting 440, a central conduit 445, and an internal valve 450 having a valve poppet 470.

In some embodiments, the fill nozzle assembly 400 is coupled to the flange 134 (e.g., using fasteners such as bolts B and nuts N) via a mounting ring 460 having a plurality of openings corresponding to openings (e.g., threaded openings) in the flange 134. The mounting ring 460 is optionally coupled (e.g., welded) to conduit 445.

In some embodiments, the fill nozzle assembly 400 optionally comprises first and second fill nozzles 410-1a, 410-1b disposed and/or oriented toward a first (e.g., left) lateral side of the vessel 100. The first and second fill nozzles are optionally disposed to be accessed by an operator positioned at the first lateral side of the vessel 100.

In some implementations, during liquid filling (e.g., liquid fuel filling) operations a first liquid supply hose is connected to the thing.

In some embodiments, the fill nozzle assembly 400 optionally comprises third and fourth fill nozzles 410-2a, 410-2b disposed and/or oriented toward a second (e.g., right) lateral side of the vessel 100. The third and fourth fill nozzles are optionally disposed to be accessed by an operator positioned at the second lateral side of the vessel 100.

Although various embodiments have been described above, the details and features of the disclosed embodiments are not intended to be limiting, as many variations and modifications will be readily apparent to those of skill in the art. Accordingly, the scope of the present disclosure is intended to be interpreted broadly and to include all variations and modifications within the scope and spirit of the appended claims and their equivalents. For example, any feature described for one embodiment may be used in any other embodiment.

1. A fuel transport system, comprising:
a fuel transport vessel;
a liquid fill assembly comprising at least a first liquid fill nozzle; and
a standpipe disposed inside said fuel transport vessel, wherein an inlet of said standpipe is fluidly coupled to said liquid fill assembly, wherein an outlet of said standpipe is disposed near an upper end of said vessel.

2. The fuel transport system of claim 1, wherein said liquid fill assembly is mounted to an underside of said fuel transport vessel.

3. The fuel transport system of claim 1, wherein said first liquid fill nozzle is disposed at least partially beneath said fuel transport vessel.

4. The fuel transport system of claim 3, wherein said first liquid fill nozzle extends toward a first side of said transport vessel.

5. The fuel transport system of claim 4, wherein said liquid fill assembly further comprises a second liquid fill nozzle.

6. The fuel transport system of claim 5, wherein said second liquid fill nozzle extends toward said first side of said fuel transport vessel.

7. The fuel transport system of claim 5, wherein said first and second liquid fill nozzles are in fluid communication with said fuel transport vessel via a tee connection.

8. The fuel transport system of claim 5, wherein said liquid fill assembly further comprises third and fourth liquid fill nozzles.

9. The fuel transport system of claim 5, wherein said and fourth liquid fill nozzles extend toward a second side of said fuel transport vessel.

10. The fuel transport system of claim 3, wherein said outlet of said standpipe comprises a plurality of openings.

11. The fuel transport system of claim 10, wherein at least one of said plurality of openings are oriented approximately horizontally.

12. A liquid fuel filling system for use with a fuel transport vessel, the system comprising:
a liquid fill assembly comprising at least a first liquid fill nozzle, the liquid fill assembly configured to be mounted to the fuel transport vessel, the liquid fill assembly configured to be fluidly coupled to the fuel transport vessel; and
a standpipe disposed inside said fuel transport vessel, wherein an inlet of said standpipe is fluidly coupled to said liquid fill assembly, wherein a height of said standpipe is greater than half of a height of the fuel transport vessel.

13. The liquid fuel filling system of claim 12, wherein said outlet of said standpipe comprises a plurality of openings.

14. The liquid fuel filling system of claim 13, wherein at least one of said plurality of openings are oriented approximately horizontally.

15. The liquid fuel filling system of claim 12, wherein said liquid fill assembly further comprises a second liquid fill nozzle.

16. The liquid fuel filing system of claim 15, wherein said first and second liquid fill nozzles are in fluid communication with said fuel transport vessel via a tee connection.

17. A method of filling a transport vessel with a fuel product, comprising:
fluidly coupling a fill hose to a liquid fill nozzle;
moving fluid-phase fuel product through said liquid fill nozzle; and
introducing said fluid-phase fuel product into a vapor space of said transport vessel via a standpipe.

18. The method of claim 17, further comprising:
selecting one of a plurality of liquid fill nozzles of a liquid fill nozzle assembly, wherein said step of fluidly coupling a fill hose to a liquid fill nozzle is applied to the selected one of said plurality of liquid fill nozzles.

19. The method of claim 17, further comprising:
dividing said fluid-phase fuel product between a plurality of outlets in said vapor space.

20. The method of claim 17, wherein said step of introducing said fluid-phase fuel product into a vapor space of said transport vessel via a standpipe comprises:
moving said fluid-phase fuel product into said transport vessel at a lower end thereof; and
moving said fluid-phase fuel product upward through a fluid-containing portion of said transport vessel via said standpipe.
